(19) United States
(12) Patent Application Publication
(10) Pub. No.: US 2018/0195025 A1
(43) Pub. Date: Jul. 12, 2018

(54) POLYURETHANE AS ANTI-CREASE AGENT

(71) Applicant: Henkel AG & Co. KGaA, Duesseldorf (DE)

(72) Inventors: Doris Dahlmann, Duesseldorf (DE); Martina Seiler, Duisberg (DE); Martina Hutmacher, Duesseldorf (DE); Frank Janssen, Koeln (DE); Christina Roeleke, Moenchengladbach (DE); Karin Kania, Moenchengladbach (DE)

(73) Assignee: Henkel AG & Co. KGaA, Duesseldorf (DE)

(21) Appl. No.: 15/918,483

(22) Filed: Mar. 12, 2018

Related U.S. Application Data
(63) Continuation of application No. PCT/EP2016/071900, filed on Sep. 15, 2016.

(30) Foreign Application Priority Data
Sep. 16, 2015 (DE) 102015217758.0

(51) Int. Cl. C11D 3/37; C08G 18/73; C08G 18/75; C08G 18/48; C08G 18/16; C08G 18/18; C08G 18/72; C11D 3/00; C11D 11/00

(52) U.S. Cl. CPC C11D 3/3726; C08G 18/73; C08G 18/755; C08G 18/4854; C11D 11/0017; C08G 18/1883; C08G 18/161; C08G 18/722; C11D 3/001; C08G 18/168

(57) ABSTRACT

A detergent or cleaning agent for textiles, containing at least one surfactant and at least one polyurethane as an anti-crease agent, and to the use of polyurethanes as an anti-crease agent for textiles.

### FIELD OF THE INVENTION

The present invention relates to a detergent or cleaning agent for textiles which contains at least one surfactant and at least one polyurethane as anti-crease agent, as well as the use of polyurethanes as an anti-crease agent for textiles.

### BACKGROUND OF THE INVENTION

According to consumer surveys, ironing is a very burdensome task. Thus far, nobody has succeeded in developing a detergent which improves the surface smoothness of the clothing after washing to the extent that ironing becomes unnecessary.

Whereas anti-crease compounds are known in textile equipment, application in detergents is very limited. However, cellulose-containing textiles above all are equipped when the textile materials are being produced. After the washing cycle, the thus-treated textiles have the advantage that they have fewer creases and folds, are easier to iron, and are softer and smoother than untreated cellulose textiles.

### BRIEF SUMMARY OF THE INVENTION

Compounds which are used directly in a detergent or cleaning agent and bring about a smoothing of the surface of the textiles in the washing process are little known. This is because corresponding compounds are either not incorporated in the detergent or cleaning agent, in particular if these are liquid, as it leads to instabilities in the detergent or cleaning agent, or their effect in the washing process itself becomes lost. The object of the present invention now consists of improving this secondary property in the washing process. Surprisingly it has been found that the use of specific urethane-based polymers results in a measurably clear improvement in the surface smoothness of textiles.

In a first embodiment, the object forming the basis of the invention is achieved by a detergent or cleaning agent for textiles comprising at least one polyurethane as anti-crease agent, wherein the polyurethane can be obtained by reacting
A) at least one ether of the general formula HO—(ZO)ₙ—H, in which Z stands for an aliphatic hydrocarbon functional group with 2 to 10 carbon atoms (preferably with 2 to 8 carbon atoms, particularly preferably with 2 to 4 carbon atoms) or for a cycloaliphatic hydrocarbon functional group with 5 to 12 carbon atoms (preferably with 5 to 10 carbon atoms, particularly preferably with 6 to 8 carbon atoms),
and
n stands for a number greater than or equal to 2,
with
B) at least one aliphatic and/or cycloaliphatic diisocyanate,
and
C) optionally at least one compound with at least two amino groups which, independently of one another, are selected from the primary amino group or secondary amino group.

The aliphatic hydrocarbon functional group with 2 to 10 carbon atoms (preferably with 2 to 8 carbon atoms, particularly preferably with 2 to 4 carbon atoms) or the cycloaliphatic hydrocarbon functional group with 5 to 12 carbon atoms (preferably with 5 to 10 carbon atoms, particularly preferably with 6 to 8 carbon atoms) can be present for example as alkane diyl functional group, alkene diyl functional group, cycloalkane diyl functional group, cycloalkene diyl functional group, bis(alkylene)cycloalkyl functional group or bis(alkylene)cycloalkenyl functional group, wherein all the above-named functional groups are aliphatic and possess the corresponding number of hydrocarbons.

Preferably, the ether HO—(ZO)ₙ—H has a numerically average molecular weight of from 350 to 8,000 g/mol, in particular of from 400 to 6,500 g/mol. In a preferred embodiment, n stands for a number from 2 to 500, in particular from 2 to 400, preferably from 3 to 350, particularly from 5 to 300 or from 5 to 150.

Preferably, the detergent or cleaning agent furthermore comprises at least one surfactant. In this embodiment, the detergent or cleaning agent comprises at least one surfactant as well as at least one polyurethane as anti-crease agent, wherein the polyurethane can be obtained by reacting
A) at least one ether of the general formula HO—(ZO)ₙ—H, in which Z independently of one another stands for an aliphatic hydrocarbon functional group with 2 to 10 carbon atoms (preferably with 2 to 8 carbon atoms, particularly preferably with 2 to 4 carbon atoms) or for a cycloaliphatic hydrocarbon functional group with 5 to 12 carbon atoms (preferably with 5 to 10 carbon atoms, particularly preferably with 6 to 8 carbon atoms),
and
n stands for a number greater than or equal to 2,
with
B) at least one aliphatic and/or cycloaliphatic diisocyanate,
and
C) optionally at least one compound with at least two amino groups which, independently of one another, are selected from the primary amino group or secondary amino group.

Preferably, the ether HO—(ZO)ₙ—H has a numerically average molecular weight of from 350 to 8,000 g/mol, in particular of from 400 to 6,500 g/mol. Preferably, n stands for a number from 2 to 500, in particular from 2 to 400, preferably from 3 to 350, particularly from 5 to 300 or from 5 to 150.

For the functional group Z, the definition “independently of one another” means that the ether can contain completely different functional groups Z. It is thus possible that the ether contains one functional group Z or two, three, or more functional groups Z which differ from one another within the scope of the definition of Z. The functional groups Z are connected to one another via an oxygen atom.

An aliphatic compound can be both linear and branched. An aliphatic compound can be both saturated and unsaturated. In every case and in contrast with the cycloaliphatic compound, an aliphatic compound does not contain a cyclical hydrocarbon group. This definition applies, mutatis mutandis, to aliphatic structure fragments. A cycloaliphatic compound can be both saturated and unsaturated. In every case, the cycloaliphatic compound comprises at least one cycloaliphatic functional group. This definition applies, mutatis mutandis, to cycloaliphatic structure fragments.

A hydrocarbon functional group is a structure fragment which is constructed exclusively from carbon and hydrogen. Unless explicitly defined elsewhere, a hydrocarbon functional group is unsubstituted.

Within the scope of the invention, a polymer is a substance which is constructed from a plurality of molecules by polyreaction in which one type or several types of atoms or atoms groupings (so-called constitutive units, basic modules or repeat units) are repeatedly connected in series. Such polymer molecules have a molar mass of at least 1000 g/mol.

In a further embodiment, the object forming the basis of the present invention is characterized by the use of polyurethanes, as described in the present application, as anti-crease agent for textiles.

In yet another further embodiment, the present invention relates to a method for reducing creases in textiles during washing, which is characterized in that a polyurethane as described in the present description, is brought into contact with the textile, in particular as a component of a detergent or cleaning agent.

Textiles within the scope of the present invention comprise textile fibers, linear textile structures produced therefrom, such as e.g. yarns and twines, laminar textile structures such as e.g. webs, knitted fabrics, crocheted fabrics, braided products, stitch-bonded fabrics, nonwoven fabrics and felts and spatial textile structures (solid structures) such as e.g. textile tubes, hoses or textile semi-finished products for reinforced plastic components and those finished products which, by assembling, opening and/or other processes, are brought in sale-ready state for forwarding to fabricators, the trade or end-consumers, using the above-named products. The textiles may consist of or comprise any known materials such as for example natural or synthetic materials such as cotton, linen, hemp, polyester, viscose, wool, pure new wool etc. Preferably, the textile within the scope of the present invention comprises a natural material, selected from cotton, linen, wool and/or hemp, particularly preferably it comprises or is made of cotton.

Detergents or cleaning agents within the scope of the invention are all types of detergents or cleaning agents, such as for example heavy-duty detergents, color detergents, mild detergents etc. Likewise, according to the invention, fabric softeners are also included. The agents according to the invention (detergents or cleaning agents) come into contact with the textile preferably during a washing or cleaning cycle, which comprises the softening cycle.

The detergent or cleaning agent according to the invention can be solid or liquid. In particular it is liquid. For example, it is a liquid detergent or laundry fabric softener. Surprisingly, it has been shown that the polyurethanes according to the invention can be well incorporated into the liquid detergents. Corresponding liquid agents are storage-stable. Coagulation or separation cannot be seen. Simultaneously, after a washing or cleaning process, a clearly measurably better surface smoothness of the textiles results, using the detergent or cleaning agent according to the invention.

The polyurethane according to the invention can be obtained by reacting at least one said ether of the general formula HO—(ZO)ₙ—H, at least one aliphatic and/or cycloaliphatic isocyanate as well as optionally at least one diamine compound. Surprisingly it has been shown that corresponding ethers are particularly suitable as the basis of corresponding polyurethanes in order to act as anti-crease agent. Polyurethanes based on polyester polyurethanes cannot be incorporated in stable manner in liquid detergent and cleaning agents and have a lower anti-crease effect.

The ether has the general formula HO—(ZO)ₙ—H. In this formula, Z stands, independently of one another, for an aliphatic hydrocarbon functional group with 2 to 10 carbon atoms (preferably with 2 to 8 carbon atoms, particularly preferably with 2 to 4 carbon atoms), or for a cycloaliphatic hydrocarbon functional group with 5 to 12 carbon atoms (preferably with 5 to 10 carbon atoms, particularly preferably with 6 to 8 carbon atoms), i.e. the ether can be saturated or unsaturated, n is as defined above. Suitable ethers are derived preferably from 1,2-propylene glycol, 1,2-butanediol, 1,3-propylene glycol, 1,4-butanediol, 1,5-pentanediol, 1,6-hexanediol and/or neopentyl glycol. Particularly preferably, said ether of the present application is deserved from 1,3-propylene glycol, 1,4-butanediol, 1,5-pentanediol or 1,6-hexanediol, particularly preferably from 1,4-butanediol. Particularly preferably, said ether is thus an aliphatic, saturated ether of the general formula HO—((CHR)ₘO)ₙ—H, wherein R independently of one another stands for a hydrogen atom, a methyl group or an ethyl group (quite particularly preferably for a hydrogen atom), m stands for an integer of from 2 to 12, in particular of from 2 to 10, preferably of from 3 to 8, in particular of from 3 to 6 and particularly preferably for 4. Quite particularly preferably, in the above general formula HO—((CHR)ₘO)ₙ—H, R stands for a hydrogen atom. m stands for a number of from 2 to 10, in particular of from 3 to 8, particularly preferably of from 3 to 6 and quite particularly preferably for 4; n stands for a number as defined above.

The at least one diisocyanate is an aliphatic and/or cycloaliphatic compound. The at least one diisocyanate is preferably selected from the group which contains C₂- to C₁₂-alkyl diisocyanates, C₆- to C₁₂-cyclohexyl diisocyanates, 1-methyl-2,4-diisocyanato-cyclohexane, 1,6-diisocyanato-2,2,4-trimethylhexane, 1,6-diisocyanato-2,4,4-trimethylhexane (TMDI), tetramethoxybutane-1,4-diisocyanate, butane-1,4-diisocyanate, hexane-1,6-diisocyanate (hexamethylene diisocyanate, HDI), 4,4′-methylenebis(cyclohexyl isocyanate) (H₁₂MDI), cyclohexane-1,4-diisocyanate, isophorone diisocyanate (5-isocyanato-1-isocyanatomethyl-1,3,3-trimethyl cyclohexane, IPDI), ethylene diisocyanate as well as mixtures thereof.

According to the invention those polyurethanes which are obtained by reacting with at least one aliphatic and at least one cycloaliphatic diisocyanate, in particular with an aliphatic diisocyanate (preferably hexamethylene diisocyanate) and a cycloaliphatic diisocyanate (preferably isophorone diisocyanate) are particularly preferred.

It is likewise possible, in addition to said ether A) to react the isocyanate compound B) with an aliphatic diol compound which has two hydroxyl groups and at least one anionic group. The diol compound contains preferably at least one anionic group selected from carboxylate (—COO⁻), sulfonate (—SO₃⁻) or sulfate (—O—SO₃⁻), in particular sulfonate or sulfate, particularly preferably sulfonate. These anionic diol compounds are present in particular in the form of their salts, in particular their alkali metal or alkaline-earth metal salts, for example sodium salt.

The polyurethane according to the invention can preferably be obtained by reacting
A) at least one ether of the general formula HO—(ZO)ₙ—H, in which Z independently of one another stands for an aliphatic hydrocarbon functional group with 2 to 10 carbon atoms (preferably with 2 to 8 carbon atoms, particularly preferably with 2 to 4 carbon atoms) or for a cycloaliphatic hydrocarbon functional group with 5 to 12 carbon atoms (preferably with 5 to 10 carbon atoms, particularly preferably with 6 to 8 carbon atoms), and n stands for a number greater than or equal to 2,
with
B) at least one aliphatic and/or cycloaliphatic diisocyanate,
and
C) at least one compound with at least two amino groups which, independently of one another, are selected from the primary amino group or secondary amino group.

Said compound with at least two amino groups which, independently of one another, are selected from the primary amino group or secondary amino group, thus contains at least two structure fragments of the formula —NH—. The amino group of the formula —NH— stands, independently of one another, for a bivalent structure fragment which, in the compound, bonds to a carbon atom and to a hydrogen atom (primary amino group), or a bivalent structure fragment which, in the compound, bonds to a carbon atom and to a further carbon atom (secondary amino group).

Said amine compound thus has, as said amino groups of the formula —NH—, at least two primary amino groups, or at least two secondary amino groups or at least one primary amino group and at least one secondary amino group.

The at least one said compound with at least two amino groups can serve as a chain extender.

Preferably, the polyurethane is produced by using at least one compound selected from aliphatic compounds with at least two said amino groups or cycloaliphatic compounds with at least two said amino groups or mixtures thereof.

Corresponding diamine compounds but also triamines such as diethylene triamine or 1,8-diamino-4-amino methyloctane can be used as said compound with at least two said amino groups.

It is particularly preferred if said compound bears two amino groups, precisely two of said amino groups. Hereinafter, these particularly preferred compounds are called diamine compound.

Preferably, the polyurethane is produced by using at least one diamine compound, selected from aliphatic diamine compounds or cycloaliphatic diamine compounds or mixtures thereof.

Suitable diamine compounds are for example 1,2-diaminoethane, diaminopropane (in particular 1,3-diaminopropane), diaminobutane (in particular 1,4-diaminobutane), diaminohexane (in particular 1,6-diaminohexane), piperazine, 2,5-dimethylpiperazine, amino-3-aminomethyl-3,5,5-trimethyl cylohexane (isophorone diamine), 4,4-diamino dicyclohexyl methane, 1,4-diamino cyclohexane, aminoethyl ethanolamine. Furthermore, triamines, such as diethylene triamine or 1,8-diamino-4-amino methyloctane can also be used. Particularly preferably, a diamine or mixtures of several different diamine compounds are used. Particularly preferably, the at least one diamine is selected from 1,2-diaminoethane, diaminopropane (in particular 1,3-diaminopropane), and/or diaminobutane (in particular 1,4-diaminobutane), quite particularly preferably 1,2-diaminoethane.

In addition to two said amino groups, the diamine can also contain a further functional group, in particular an anionic group selected from carboxylate (—COO⁻), sulfonate (—SO₃⁻) or sulfate (—O—SO₃⁻), in particular sulfonate or sulfate, particularly preferably sulfonate. These anionic diamine compounds are present in particular in the form of their salts, in particular their alkali metal or alkaline-earth metal salts, for example sodium salt. The at least one diamine compound with an anionic group (anionic diamine compound) is particularly preferably N-(2-aminoethyl)-2-aminoethane sulfonic acid, N-(2-aminoethyl)-3-aminopropane sulfonic acid, N-(3-aminopropyl)-2-aminoethane sulfonic acid or N-(3-aminopropyl)-3-aminopropyl sulfonic acid, particularly preferably N-(2-aminoethyl)-2-aminoethane sulfonic acid. These anionic diamine compounds are present in particular in the form of their salts, in particular their alkali metal or alkaline-earth metal salts, for example sodium salt.

According to the invention it is preferred if firstly a prepolymer of ether A) and diisocyanate B) is produced and the diamine compound of C) is then reacted with the obtained prepolymer. When reacting C) with the prepolymer of A) and B), ether A) and diisocyanate B) can additionally be added.

If a used diamine compound has an anionic group, then the polyurethane can preferably be obtained by reaction with at least two diamine compounds, wherein at least one diamine compound has an anionic group and at least one diamine compound does not have any anionic group. In this preferred embodiment, the polyurethane can preferably be obtained by reacting
A) at least one ether of the general formula HO—(ZO)ₙ—H, in which Z stands for an aliphatic hydrocarbon functional group with 2 to 10 carbon atoms (preferably with 2 to 8 carbon atoms, particularly preferably with 2 to 4 carbon atoms), or for a cycloaliphatic hydrocarbon functional group with 5 to 12 carbon atoms (preferably with 5 to 10 carbon atoms, particularly preferably with 6 to 8 carbon atoms),
and
n stands for a number from 2 to 500, in particular from 2 to 400, preferably from 3 to 350, particularly from 5 to 300 or from 5 to 150.
with
B) at least one aliphatic and/or cycloaliphatic diisocyanate,
and
C) at least two diamine compounds, wherein at least one diamine compound has an anionic group and at least one diamine compound does not have any anionic group.

In a particularly preferred embodiment, the polyurethane can preferably be obtained by reacting
A) at least one ether of the general formula HO—((CH2)ₘO)ₙ—H, in which m stands for an integer of from 2 to 12, in particular of from 2 to 10, preferably of from 2 to 4, and n stands for a number greater than or equal to 2, preferably of from 2 to 500, particularly preferably of from 2 to 400, quite particularly preferably of from 3 to 350, preferentially of from 5 to 300 or most preferably of from 5 to 150
with
B) at least one aliphatic and at least one cycloaliphatic diisocyanate, and
C) at least two diamine compounds, wherein at least one diamine compound has an anionic group and at least one diamine compound does not have any anionic group.

The thus-obtained polyurethanes are anionic polyether polyurethanes. The at least one diamine compound with an anionic group (anionic diamine compound) is particularly preferably N-(2-aminoethyl)-2-aminoethane sulfonic acid or N-(2-aminoethyl)-3-aminopropane sulfonic acid, or N-(3-aminopropyl)-2-aminoethane sulfonic acid or N-(3-aminopropyl)-3-aminopropane sulfonic acid, particularly preferably N-(2-aminoethyl)-2-aminoethane sulfonic acid. These anionic diamine compounds are present in particular in the form of their salts, in particular their alkali metal or alkaline-earth metal salts, for example sodium salt.

Those polyurethanes which have a glass transition temperature, determined according to DIN EN 61006, of −50° C. or less, in particular of −60° C. or less, are particularly preferred. The glass transition temperature TG is the temperature which, when exceeded, sees the solid polymer convert into a rubbery to viscous melt.

The polyurethanes of the present invention are film-forming polymers. Film-forming polymers are understood to mean such polymers which, upon drying, leave a continuous film on the surface to which they are applied. For example, they adhere to the fibers of the textile during washing, as a component of a detergent or cleaning agent, whereby, without being tied to this theory, a reduced creasing and a better smoothness of the surface is made possible. This ensures that textiles can be ironed better. A corresponding polyurethane film has preferably a contact angle of 78° or more, preferably of from 80° or more, in particular of from 82° or more, with water, at room temperature.

The further physical properties of the polyurethane film which forms on a surface can also be investigated. Preferred polyurethanes or the films thereof have a tensile strength of less than 40 MPa, in particular of 35 MPa or less, particularly preferably of 30 MPa or less. The tensile strength is a material property which describes the maximum mechanical tensile stress the material can withstand before it breaks or tears. The tensile test calculates the maximum achieved pull force relative to the original cross-section of the sample. Other polyurethanes known in the prior art or films obtained therefrom have a tensile strength of 40 MPa or more. The low tensile strength of a polyurethane film seems particularly suitable for making possible an adhesion of the polymer to textiles and thus achieving a particularly good effect with regard to anti-crease properties as well as simplified ironing. Due to the low tensile strength, a removal of the film after treatment, e.g. during the mechanical stress of bearing, is made easier, and thus an undesired accumulation of the polyurethane film on the textile surface by repeated applications (the so-called built-up effect) is avoided.

The polyurethane of the present invention is a component of a detergent or cleaning agent. In a preferred embodiment, the polyurethane can be obtained by reacting at least one ether of the general formula HO—((CH2)ₘO)ₙ—H, wherein m and n are as defined above, with an aliphatic diisocyanate and a cycloaliphatic diisocyanate, an aliphatic diamine compound and a diamine compound with an anionic group. The obtained polyurethane is an anionically-modified polyether polyurea.

In the present invention, unless otherwise indicated, the quantity details given in percentages relate to wt.-% relative to the total weight of the agent according to the invention. If ranges are indicated, the values included therebetween are thus also to be considered as being disclosed.

The detergent or cleaning agent according to the invention can be liquid or solid. Suitable liquid detergent or cleaning agents comprise at least one surfactant, selected from non-ionic, anionic and amphoteric surfactants. Suitable liquid detergent or cleaning agents are described for example in WO 2011/117079A1, WO 2013/186170A1 or WO 2013/107579A1, to which reference is made here expressly. If the detergent or cleaning agent is solid, it comprises one or more washing or cleaning active substances, preferably selected from the group of builders, surfactants, polymers, bleaching agents, bleach activators and enzymes.

### DETAILED DESCRIPTION OF THE INVENTION

The detergent or cleaning agent according to the invention has preferably a pH (20° C.) in the base range, thus of more than 7, in particular in the range of from greater than 7 to 14, preferably of from 7.5 to 12, in particular of from 8 to 10. Surprisingly it has been shown that, at base pH values, polyester polyurethanes, as described in the prior art, can be worked into detergents or cleaning agents, in particular into liquid detergents or cleaning agents, in stable manner. Surprisingly it has been shown that this is possible with the polyurethanes according to the invention, whereby liquid formulations of detergent or cleaning agents which are storage-stable, without the polyurethane coagulating or a phase separation taking place, are made possible.

The surfactants both for a solid and also for a liquid formulation of the agent according to the invention and as further optional components are described in more detail below:

The groups of surfactants include non-ionic, anionic, cationic and amphoteric surfactants. According to the invention the detergent or cleaning agent can comprise one or more of the named surfactants. Particularly preferably it comprises at least one or more anionic surfactants, which are contained in the agent according to the invention preferably in a proportion of from 5 to 50 wt.-%, in particular of from 5 to 35 wt.-%.

The at least one anionic surfactant is preferably selected from the group comprising C₉- to C₁₃-alkylbenzene sulfonates, olefin sulfonates, C₁₂- to C₁₈-alkane sulfonates, ester sulfonates, alk(en)yl sulfates, fatty alcohol ether sulfates and mixtures thereof. It has been shown that these sulfonate and sulfate surfactants are particularly suitable for producing stable liquid compositions with a yield point. Liquid compositions which comprise C₉- to C₁₃-alkylbenzene sulfonates and fatty alcohol ether sulfates as anionic surfactants have particularly good dispersing properties. As sulfonate-type surfactants preferably C₉- to C₁₃-alkylbenzene sulfonates, olefin sulfonates, i.e. mixtures of alkene and hydroxy alkane sulfonates and disulfonates, as for example are obtained from C₁₂- to C₁₈-monoolefins with terminal or internal double bond by sulfonating with gaseous sulfur trioxide and then alkali or acid hydrolysis of sulfonation products, come into consideration. Also, C₁₂- to C₁₈-alkane sulfonates and the esters of α-sulfo fatty acids (ester sulfonates), for example the α-sulfonated methyl esters of hydrogenated palmitic, palm kernel or tallow fatty acids, are suitable.

The alkali and in particular sodium salts of sulfuric acid semiesters of C₁₂- to C₁₈-fatty alcohols, for example of coconut oil alcohol, tallow fat alcohol, lauryl, myristyl, cetyl or stearyl alcohol or of C₁₀- to C₂₀-oxo alcohols and those semiesters of secondary alcohols of these chain lengths, are preferred as alk(en)yl sulfates. Of interest from a washing-related technical aspect, C₁₂- to C₁₆-alkyl sulfates and C₁₂- to C₁₅-alkyl sulfates as well as C₁₄- to C₁₅-alkyl sulfates are preferred. Also, 2,3-alkyl sulfates are suitable anionic surfactants.

Also suitable are fatty alcohol ether sulfates such as the sulfuric acid monoesters of straight-chained or branched C₇- to C₂₁-alcohols, such as 2-methyl-branched C₉- to C₁₁-alcohols with on average 3.5 mol ethylene oxide (EO) or C₁₂- to C₁₈-fatty alcohols with 1 to 4 EO, which C₇- to C₂₁-alcohols are ethoxylated with 1 to 6 mol ethylene oxide.

It is preferred that the detergent or cleaning agent contains a mixture of sulfonate and sulfate surfactants. In a particularly preferred embodiment, the composition contains C₉- to C₁₃-alkylbenzene sulfonates and fatty alcohol ether sulfates as anionic surfactant.

In addition to the anionic surfactant, the composition can also contain soaps. Saturated and unsaturated fatty acid soaps, such as the salts of lauric acid, myristic acid, palmitic acid, stearic acid, (hydrogenated) erucic acid and behenic acid as well as those soap mixtures derived in particular from natural fatty acids, for example coconut, palm kernel, olive oil or tallow fatty acids, are suitable.

The anionic surfactants and the soaps can be present in the form of their sodium, potassium or magnesium or ammonium salts. Preferably, the anionic surfactants are present in the form of their sodium salts. Further preferred opposed ions for the anionic surfactants are also the protonated forms of choline, triethylamine, ethanolamine or methylethylamine.

In addition to the anionic surfactant, the composition can have also at least one non-ionic surfactant. The non-ionic surfactant comprises alkoxylated fatty alcohols, alkoxylated fatty acid alkyl esters, fatty acid amides, alkoxylated fatty acid amides, polyhydroxy fatty acid amides, alkylphenol polyglycol ethers, aminoxides, alkylpolyglucosides and mixtures thereof.

Preferably alkoxylated, advantageously ethoxylated, in particular primary alcohols with preferably 8 to 18 C atoms and on average 4 to 12 mols ethylene oxide (EO) per mol alcohol are used as non-ionic surfactant, in which the alcohol functional group can be linear or preferably methyl-branched in the 2 position or can contain linear and methyl-branched functional groups in the mixture, as are conventionally present in oxo alcohol functional groups. However, in particular alcohol ethoxylates with linear functional groups made of alcohols of native origin with 12 to 18 C atoms, for example made of coco, palm, tallow fat or oleyl alcohol, and on average 5 to 8 EO per mol alcohol, are preferred. The preferred ethoxylated alcohols include for example C₁₂-C₁₄-alcohols with 4 EO or 7 EO, C₉- to C₁₁-alcohol with 7 EO, C₁₃- to C₁₅-alcohols with 5 EO, 7 EO or 8 EO, C₁₂- to C₁₈-alcohols with 5 EO or 7 EO and mixtures thereof. The indicated degrees of ethoxylation represent statistical averages which can be an integer or a fractional number for a special product. Preferred alcohol ethoxylates have a concentrated homolog distribution (narrow range ethoxylates, NRE). In addition to these non-ionic surfactants, fatty alcohols with more than 12 EO can thus be used. Examples of this are tallow fatty alcohol with 14 EO, 25 EO, 30 EO or 40 EO. Also non-ionic surfactants, which contain EO and PO (propylene oxide) groups together in the molecule can be used according to the invention. Furthermore, a mixture of a (more strongly) branched ethoxylated fatty alcohol and an unbranched ethoxylated fatty alcohol, such as for example a mixture of a C₁₆-C₁₈-fatty alcohol with 7 EO and 2 propylheptanol with 7 EO, is suitable. In particular, the detergent, cleaning, post-treatment or washing auxiliary agent preferably contains a C₁₂-C₁₈-fatty alcohol with 7 EO or a C₁₃-C₁₅-oxo alcohol with 7 EO as non-ionic surfactant.

The detergent or cleaning agent can also comprise one or more solvent. This can be water and/or non-aqueous solvent. Preferably, the composition contains water as main solvent. The composition can furthermore comprise non-aqueous solvent. Suitable non-aqueous solvents comprise mono- or polyvalent alcohols, alkanolamines or glycol ethers. Preferably, the solvents are selected from ethanol, n-propanol, i-propanol, butanolene, glycol, propanediol, butanediol, methylpropanediol, glycerol, diglycol, propyldiglycol, butyldiglycol, hexyleneglycol, ethyleneglycol methyl ether, ethyleneglycol ethyl ether, ethyleneglycol propyl ether, ethyleneglycol mono-n-butylether, diethyleneglycol methyl ether, diethyleneglycol ethyl ether, propyleneglycol methyl ether, propyleneglycol ethyl ether, propyleneglycol propyl ether, dipropyleneglycol monomethyl ether, dipropyleneglycol monoethyl ether, methoxytriglycol, ethoxytriglycol, butoxytriglycol, 1-butoxyethoxy-2-propanol, 3-methyl-3 -methoxybutanol, propyleneglycol-t-butylether, di-n-octylether and mixtures of these solvents.

According to the invention, the composition can also comprise builders and/or alkaline substances. For example, polymeric polycarboxylates are suitable as builders. These are for example the alkali metal salts of polyacrylic acid or of polymethacrylic acid, for example those with a relative molecular mass of 600 to 750,000 g/mol.

Suitable polymers are in particular polyacrylates which preferably have a molecular mass of 1,000 to 15,000 g/mol. In turn, from this group, the short-chained polyacrylates which have molar masses of 1,000 to 10,000 g/mol, and particularly preferably of from 1,000 to 5,000 g/mol, are preferred on the basis of their superior solubility.

Furthermore, copolymeric polycarboxylates, in particular those of acrylic acid with methacrylic acid, and acrylic acid or methacrylic acid with maleic acid, are suitable. The polymers can also contain allyl sulfonic acids, such as allyloxy benzene sulfonic acid and methallyl sulfonic acid, to improve water solubility.

As builders which can be contained in the composition according to the invention, there are in particular to be named also silicates, aluminosilicates (in particular zeolites), carbonates, salts of organic di- and polycarboxylic acids and mixtures of these substances.

Organic builders which furthermore may be present in the composition according to the invention are for example the polycarboxylic acids used in the form of their sodium salts, wherein polycarboxylic acids are understood to mean those carboxylic acids which have more than one acid function. For example, these are citric acid, adipic acid, succinic acid, glutaric acid, malic acid, maleic acid, fumaric acid, saccharic acids, amino carboxylic acids, nitrilotriacetic acid (NTA), methylglycinediacetic acid (MGDA) and derivatives as well as mixtures thereof. Preferred salts are those of polycarboxylic acids such as citric acid, adipic acid, succinic acid, glutaric acid, malic acid, saccharic acids and mixtures thereof.

Preferably, however, soluble builders, such as for example citric acid, or acryl polymers with a molar mass of 1,000 to 5,000 g/mol, are used.

Alkaline substances or wash alkalis are, within the scope of the present invention, chemicals for increasing and stabilizing the pH of the composition.

In a preferred embodiment, the detergent or cleaning agent also comprises at least one enzyme. Suitable enzymes are the enzymes named before as additives. According to the invention it is also possible that several different enzymes are included. In particular, enzyme granulates are contained in a proportion of from 4 to 15 wt.-%, preferably of from 7 to 12 wt.-%, in each case relative to 100 wt.-% of the total detergent or cleaning agent. In a particularly preferred embodiment, the at least one enzyme is present as granulate.

The detergent or cleaning agents according to the invention contain enzymes preferably in total quantities of 1×10⁸ to 5 wt.-% relative to active protein. Preferably, the enzymes are contained in a total quantity of from 0.001 to 4 wt.-%, more preferably of from 0.01 to 3 wt.-%, even more preferably of from 0.05 to 1.25 wt.-% and particularly preferably of from 0.2 to 1.0 wt.-%, in these detergent or cleaning agents.

In principle, all enzymes established in the prior art for textile treatment are suitable for use as additives. Preferably, this concerns one or more enzymes which, as the additive of a detergent, can display a catalytic activity, in particular a protease, amylase, lipase, cellulase, hemicellulase, mannanase, pectin-splitting enztme, tannase, xylanase, xanthanase, β-glucosidase, carrageenase, perhydrolase, oxidase, oxidoreductase and mixtures thereof. Preferred suitable hydrolytic enzymes comprise in particular proteases, amylases, in particular α-amylases, cellulases, lipases, hemicellulases, in particular pectinases, mannanases, β-glucanases and mixtures thereof. Particularly preferred are proteases, amylases and/or lipases and mixtures thereof, and quite particularly preferred are proteases. In principle, these enzymes are of natural origin; proceeding from the natural molecules, improved variants which are correspondingly preferably used are available for use in detergent or cleaning agents.

Preferred proteases are those of subtilisin type. Examples hereof are subtilisins BPN′ and Carlsberg, protease PB92, subtilisins 147 and 309, alkaline proteases from Bacillus lentus, subtilisin DY and the enzymes thermitase, proteinase K and proteases TW3 and TW7, which can be assigned to subtilases, but no longer to subtilisins in the narrower sense. Subtilisin Carlsberg is available in developed form under the trade names Alcalase® from Novozymes A/S, Bagsvaerd, Denmark. Subtilisins 147 and 309 are available under the trade names Esperase®, or Savinase® from Novozymes. The protease variants under the name BLAP® can be derived from the protease from Bacillus lentus DSM 5483. Further useful proteases are for example the enzymes which can be obtained under the trade names Durazym®, Relase®, Everlase®, Nafizym®, Natalase®, Kannase® and Ovozyme® from Novozymes, under the trade names, Purafect®, Purafect® OxP, Purafect® Prime, Excellase® and Properase® from Genencor, under the trade name Protosol® from Advanced Biochemicals Ltd., Thane, India, under the trade name Wuxi® from Wuxi Snyder Bioproducts Ltd., China, under the trade names Proleather® and Protease P® from Amano Pharmaceuticals Ltd., Nagoya, Japan, and under the name Proteinase K-16 from Kao Corp., Tokyo, Japan. The proteases from Bacillus gibsonii and Bacillus pumilus are also particularly preferably used.

Examples of amylases which can be used according to the invention are the α-amylases from Bacillus licheniformis, from B. amyloliquefaciens or from B. stearothermophilus as well as the developments thereof, improved for use in detergent or cleaning agents. The enzyme from B. licheniformis is available from Novozymes under the name Termamyl® and from Genencor under the name Purastar® ST. Development products of these α-amylases are available from Novozymes under the trade names Duramyl® and Termamyl® ultra, from Genencor under the name Purastar® OxAm and from Daiwa Seiko Inc., Tokyo, Japan, as Keistase®. The α-amylase of B. amyloliquefaciens is marketed by Novozymes under the name BAN®, and derived variants α-amylase of B. stearothermophilus under the names BSG® and Novamyl®, also from Novozymes. Furthermore, for this purpose, the α-amylases of Bacillus sp. A 7-7 (DSM 12368) and the cyclodextrin glucanotransferase (CGTase) of B. agaradherens (DSM 9948) are to be emphasized. Fusion products of all named molecules can likewise be used. The developments of α-amylase from Aspergillus niger and A. oryzae, available from Novozymes under the trade name Fungamyl®, are also suitable. Further advantageously usable commercial products are for example Amylase-LT®, as well as Stainzyme® or Stainzyme ultra® or Stainzyme plus®, the latter also available from Novozymes. Variants of these enzymes available also by point mutations can be used according to the invention.

Examples of lipases or cutinases which can be used according to the invention, which are contained in particular because of their triglyceride-splitting activities, but also in order to produce peracids from suitable precursors in situ, are the lipases available or developed originally from Humicola lanuginosa (Thermomyces lanuginosus), in particular those with the amino acid exchange D96L. They are marketed for example by Novozymes under the trade names Lipolase®, Lipolase® Ultra, LipoPrime®, Lipozyme® and Lipex®. Furthermore, for example the cutinases can be used which have originally been isolated from Fusarium solani pisi and Humicola insolens. Similarly usable lipases can be obtained from Amano under the names Lipase CE®, Lipase P®, Lipase B®, or Lipase CES®, Lipase AKG®, Bacillus sp. Lipase®, Lipase AP®, Lipase M-AP® and Lipase AML®. From Genencor, for example the lipases or cutinases can be used, the starting enzymes of which have been isolated originally from Pseudomonas mendocina and Fusarium solanii. Further important commercial products to be mentioned are the preparations M1 Lipase® and Lipomax® marketed originally by Gist-Brocades and the enzymes under the names Lipase MY-30®, Lipase OF® and Lipase PL® marketed by Meito Sangyo KK, Japan, as well as the product Lumafast® from Genencor.

Cellulases may be present depending on the purpose as pure enzymes, as enzyme preparations or in the form of mixtures in which the individual components are advantageously supplemented in respect of their different performance aspects. These performance aspects include in particular the contributions of cellulase to the primary washing performance of the agent (cleaning performance), to the secondary washing performance of the agent (antiredeposition effect or graying inhibition), for reviving (tissue effect) or for bringing about a “stone washed” effect. A usable fungal, endoglucanase (EG)-rich cellulase preparation, or the developments thereof, is supplied by Novozymes under the commercial name Celluzyme®. The products Endolase® and Carezyme® likewise available from Novozymes are based on 50 kD-EG, or 43 kD-EG from H. insolens DSM 1800. Further commercial products from this company which can be used are Cellusoft®, Renozyme® and Celluclean®. Furthermore, for example 20 kD-EG from Melanocarpus, which are available from AB Enzymes, Finland, under the trade names Ecostone® and Biochips®, can be used. Further commercial products from AB Enzymes are Econase® and Ecopulp®. Further suitable cellulases are from Bacillus sp. CBS 670.93 and CBS 669.93, wherein the one from Bacillus sp. CBS 670.93 can be obtained from Genencor under the trade name Puradax®. Further commercial products from Genencor are “Genencor detergent cellulase L” and IndiAge® Neutra. Variants of these enzymes available also by point mutations can be used according to the invention. Particularly preferred cellulases are thielavia terrestris cellulase variants, cellulases from melanocarpus, in particular melanocarpus albomyces, EGIII-type cellulases from trichoderma reesei or variants available herefrom.

Furthermore, in particular for removing specific problem stains, further enzymes can be used which are summarized under the term hemicellulases. These include for example mannanases, xanthanlyases, xanthanases, xyloglucanases, xylanases, pullulanases, pectin-splitting enzymes and β-glucanases. The β-glucanase which can be obtained from Bacillus subtilis is available under the name Cereflo® from Novozymes. Hemicellulases particularly preferred according to the invention are mannanases which for example are marketed under the trade names Mannaway® by Novozymes or Purabrite® by Genencor. The pectin-splitting enzymes within the scope of the present invention are also those with the names pectinase, pectate lyase, pectinesterase, pectin demethylase, pectinmethoxylase, pectinmethyl esterase, pectase, pectinmethyl esterase, pectino esterase, pectinpectyl hydrolase, pectin depolymerase, endopolygalacturonase, pectolase, pectin hydrolase, pectin-polygalacturonase, endo-polygalacturonase, poly-α-1,4-galacturonide glycanohydrolase, endogalacturonase, endo-D-galacturonase, galacturane 1,4-α-galacturonidase, exopolygalacturonase, poly(galacturonate) hydrolase, exo-D-galacturonase, exo-D-galacturonanase, exopoly-D-galacturonase, exo-poly-α-galacturonosidase, exopolygalacturonosidase or exopolygalacturanosidase. Examples of enzymes which are suitable in respect can for example be obtained under the names Gamanase®, Pektinex AR®, X-Pect® or Pectaway® from Novozymes, under the name Rohapect UF®, Rohapect TPL®, Rohapect PTE100®, Rohapect MPE®, Rohapect MA plus HC, Rohapect DA12L®, Rohapect 10L®, Rohapect B1L® from AB Enzymes and under the name Pyrolase® from Diversa Corp., San Diego, Calif., USA.

Among these enzymes those particularly preferred are the ones which are comparatively stable against oxidation or for example have been stabilized via point mutagenesis. These include in particular the already mentioned commercial products Everlase® and Purafect® OxP as examples of such proteases and Duramyl® as an example of such an α-amylase.

It is preferred that an optical brightener is selected as additive from the substance classes of distyrylbiphenyls, stilbenes, 4,4′-diamino-2,2′-stilbene disulfonic acids of coumarin, of dihydro quinolinone, of 1,3-diarylpyrazoline, of naphthalic acid imides, of benzoxazole systems, of benzisoxazole systems, of benzimidazole systems, of pyrene derivatives substituted by heterocyclene, and mixtures thereof. These substance classes of optical brighteners have a high stability, a high light and oxygen resistance and a high affinity to fibers.

The following optical brighteners, which are selected from the group consisting of disodium-4,4′-bis-(2-morpholino-4-anilino-s-triazine-6-ylamino)stilbene disulfonate, disodium-2,2′-bis-(phenyl-styryl)disulfonate, 4,4′-Bis[(4-anilino-6-[bis(2-hydroxyethyl)amino]-1,3,5-triazine-2-yl)amino]stilbene-2,2′-disulfonic acid, hexasodium-2,2′-[vinylenebis[(3-sulphonato-4,1-phenylene)imino[6-(diethylamino)-1,3,5-triazine-4,2-diyl]imino]]bis-(benzol-1,4-disulfonate), 2,2′-(2,5-thiophendiyl)bis[5-1,1-dim, can be incorporated well and stably as additives.

Both the powdery and the liquid detergent or cleaning agent can have one or more components described further in the prior art, such as for example optical brighteners, complexing agents, bleaching agents, bleach activators, antioxidants, enzyme stabilizers, antimicrobial active ingredients, graying inhibitors, antiredeposition agents, pH adjusters, electrolytes, laundry performance enhancers, vitamins, proteins, foam inhibitors and/or UV absorbers.

Surprisingly it has been shown that anionically-modified polyether polyurethanes can be dissolved particularly well and stably in corresponding detergent or cleaning agents, with the result that these do not coagulate even after a longer storage period. If the agent according to the invention is a fabric softener, then the polyurethane is present preferably in non-anionically-modified form. Instead, it is an otherwise described polyether polyurethane.

A laundry fabric softener according to the invention as an embodiment of a detergent or cleaning agent comprises components common to laundry fabric softeners, such as one or more textile-softening compounds, fragrance compositions and further additives such as for example alcohols, amphoterols, non-ionic surfactants, pH buffer substances, enzymes, fungicides or antioxidants.

A fabric softener usually comprises a textile-softening compound. It is preferred that the textile-softening compound is selected from the group of quaternary ammonium compounds, polysiloxanes, textile-softening clays and mixtures thereof. These compounds are effective and commercially very available textile-softening compounds.

Furthermore, it is particularly advantageous that the fabric softener as textile-softening compound contains a quaternary ammonium compound. In particular it is preferred that the quaternary ammonium compound is a compound of the following general formula (B):

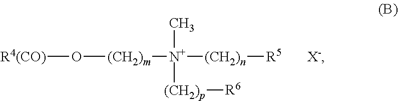

wherein
R⁴ stands for an aliphatic alk(en)yl functional group with 11 to 21 carbon atoms with 0, 1, 2 or 3 double bonds and/or optionally with substituents;
R⁵ stands for H, OH or 0(CO)R⁷,
R⁶ independently of R⁵ stands for H, OH or O(CO)R⁸, wherein R⁷ and R⁸, independently of one another, stand for an aliphatic alk(en)yl functional group with 11 to 21 carbon atoms with 0, 1, 2 or 3 double bonds,
m, n and p can each independently of one another have the value 1, 2 or 3 and
X⁻ can be either a halide, methosulfate, methophosphate or phosphate ion as well as mixtures of these anions.

In softeners which contain quaternary ammonium compounds and in particular mono, di and/or triesters of fatty acids with alkanol amines as textile-softening compounds, a particularly marked increase in viscosity us achieved by a C16-fatty material which in a preferred embodiment is contained in the end-product according to the invention.

The pH of the fabric softener is preferably in the range of from 1 to 6, particularly preferably of from 1.5 to 3.5.

Additionally, the laundry fabric softener usually also comprises a thickener, for example a cationic acrylic polymer.

Preferably, the cationic acrylic polymer is present in the form of solid particles. Preferably, the particles are spherical particles which in particular are ball-shaped. The average particle size (average volume diameter) of the solid particles is in particular in the range of from 100 to 900 μm, preferably in the range of from 200 to 800 μm, particularly preferably in the range of from 250 to 750 μm. If the solid particles are present ball-shaped, then the diameter of the sphere corresponds to the particle size. In all other spherical shapes, the particle size corresponds to the size of the particle with the greatest spatial expansion. The particle size can be determined by means of raster electron microscope (REM) images.

The cationic acrylic polymer is hygroscopic. With too small a particle size of 100 μm or less, in particular of 200 μm or less, particularly of 250 μm or less, it is possible for so much water to accumulate on the surface of the particle that a stable suspension is no longer obtained. Instead, this leads to a swelling of the acrylic polymer, with the result that after mixing with a suspension agent according to the invention, no dispensable suspension, but a highly-viscous, rubbery mass is obtained. If the particle size is, in contrast, more than 900 μm, then these large and thus also heavier particles can sediment more quickly than particles with a size of 900 μm or less, in particular of 800 μm or less, particularly of 750 μm or less.

Suitable cationic acrylic polymers which can be used as thickeners according to the invention are for example described in WO 03/102043 A1 on pages 1 to 4, to the entire content of which reference is made. The cationic acrylic polymers according to the invention are therefore preferably formed from
a) a water-soluble ethylenically unsaturated monomer or a mixture of these monomers which comprise at least one cationic monomer,
b) at least one cross-linker in a quantity of more than 50 ppm, relative to the weight of compound a), and
c) at least one chain transmitter.

The cationic monomer corresponds preferably to a compound according to the following compound (I)

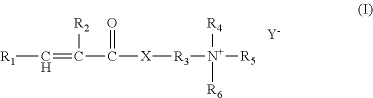

in which, independently of one another
R₁ represents hydrogen or methyl,
R₂ represents hydrogen or C₁ to C₄-alkyl,
R₃ represents C₁-C₄-alkylene,
R₄, R₅ and R₆ each independently of one another represent another hydrogen or C₁ to C₄-alkyl,
X represents —O— or —NH— and
Y represents Cl, Br, I, hydrogensulfate or methosulfate.

The respective alkyl groups can be linear or branched.

Cross-linker b) comprises preferably at least two ethylenically unsaturated units. Suitable preferred cross-linkers are divinylbenzene, tetraallyl ammoniumchloride, allylacrylates and allylmethacrylates, diacrylates and dimethacrylates of glycolene and polyglycolene, butadiene 1,7-octadiene, allylacrylamides and allylmethacrylamide, bisacrylamido acetic acid, N,N′-methylene bisacrylamide and polyol polyallylether, such as for example polyallylsaccharose and pentaerythritoltriallylether. Particularly preferred cross-linkers are tetraallyl ammoniumchloride, allylacrylamide and allylmethacrylamide, bisacrylamido acetic acid and N,N′-methylene bisacrylamide. Tetraallyl ammoniumchloride and N,N′-methylene bisacrylamide are quite particularly preferred as cross-linker. Mixtures of the cross-linkers can also be used.

In a preferred embodiment, the cationic acrylic polymer has at least one cross-linker b) in a proportion of from 50 to 1200 ppm, preferably of from 500 to 1000 ppm and particularly preferably of from 700 to 900 ppm, relative in each case to the weight of component a).

Chain transmitter c) is preferably selected from the group which comprises mercaptans, malic acid, lactic acid, formic acid, isopropanol and hypophosphite. Preferably, the content of chain transmitter c) is of from 10 to 50,000 ppm, preferably of from 100 to 10,000 ppm, relative in each case to the weight of component a).

In a particularly preferred embodiment, the cationic acrylic polymer is formed as a cationic monomer from the formula (Ia) shown below:

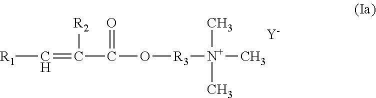

in which, independently of one another
R₁ represents hydrogen or methyl,
R₂ represents hydrogen or methyl,
R₃ represents C₁-C₂-alkylene, and
Y represents Cl, Br or l
and
i) the at least one cross-linker is selected from group which consists of divinylbenzene, tetraallyl ammoniumchloride, allylacrylates and allylmethacrylates, diacrylates and dimethacrylates of glycols and polyglycols, butadiene, 1,7-octadiene, allylacrylamides and allylmethacrylamides, bisacrylamido acetic acid, N,N′-methylene bisacrylamide and polyolpolyallylether, is contained in a quantity of from 50 to 1,200 ppm, preferably in a quantity of from 50 to 1,000 ppm, in particular preferably in a quantity of from 700 to 900 ppm, relative in each case to the weight of component a), and
ii) at least one chain transmitter which is selected from the group which comprises malic acid, lactic acid, formic acid, isopropanol and hypophosphites, is contained in a quantity of from 1,000 to 9,000 ppm, preferably in a quantity of from 2,000 to 5,000 ppm, relative in each case to the weight of component a).

A detergent or cleaning agent according to the invention comprises the polyurethane according to the invention preferably in a proportion of from 0.01 to 30 wt.-%, in particular of from 0.05 to 20 wt.-%, in particular of from 0.05 to 10 wt.-%, in particular of from 0.1 to 5 wt.-%, particularly of from 0.1 to 4 wt.-%. It has been shown that a smaller proportion of polyurethanes both in the fabric softener and also in further detergent or cleaning agents does not lead to the desired effect. An additional amount of polyurethane indeed does not indeed impair the cleaning or softening performance of the corresponding agents. However, an increase in the desired anti-crease effect and easy ironing effect (ironing auxiliary) cannot be established, with the result that in particular a proportion of from 0.1 to 10 wt.-% appears sufficient to achieve the desired effect. Particularly preferably, a proportion of 5 wt.-% or less is sufficient.

In a further embodiment, the object forming the basis of the present invention is achieved by using polyurethanes, as described in the present application, as anti-crease agent for textiles. Surprisingly it has been shown that the described polyurethanes lead to the desired effect.

In yet another further embodiment, the present invention relates to a method for reducing creases in textiles during washing, which is characterized in that a polyurethane as described in the present application and in particular as a component of a detergent or cleaning agent is brought into contact with the textile. In contrast to the anti-crease agents described in the prior art, a pre-treatment with the agents according to the invention is not possible. Instead, the present invention makes it possible to incorporate the polyurethanes according to the invention stably in a detergent or cleaning agent which includes laundry fabric softener. At the same time as being cleaned, the textiles are also equipped with the anti-crease agent.

According to the invention, the bringing into contact in a machine cleaning of textiles takes place in particular in a washing machine. However, it is also possible in manual cleaning to bring the detergent or cleaning agent either directly into contact with the textiles or immediately to produce an aqueous solution of the detergent or cleaning agent (detergent solution) according to the invention and bring this detergent solution into contact with the textile. A specific exposure time of the polyurethane on the textile is surprisingly not necessary.

In the embodiment example below the present invention is explained by way of example in non-limiting manner. Within the scope of the present invention, all above-listed and also preferred embodiments, or the respective described features, can also be combined with one another individually. Additionally, within the scope of the present invention, the term “comprise” also covers the alternatives in which the products/methods/uses with respect to which the term “comprising” is used, exclusively for the existing elements described subsequently.

### EMBODIMENT EXAMPLES

The polyurethane used is an anionically-modified polyether polyurethane which is described using the INCI name polyurethane-32 and is usually used in the field of cosmetics. It can be obtained from polytetramethylene glycol, hexamethylene diisocyanate, isophorone diisocyanate, ethylenediamine and N-(2-aminoethyl)-2-aminoethane sulfonic acid.

### Embodiment Example 1

### Composition of the Detergent

Different textiles (cotton fabric and polyester/cotton mixed fabric) are washed with a liquid detergent (formulation 1, comparative example) and once with the liquid detergent according to formulation 1 with the addition of 0.5% of a polyurethane compound (polyurethane-32) (formulation 2, according to the invention). The different fabrics were each washed separately at 40° C. (using the easy care program) in a standard washing machine from Miele. Five washing cycles were carried out.

After three washes, interim drying took place overnight.

The two formulations are described in the following table. The details are given in each case in wt.-%

| Composition | Formulation 1 | Formulation 2 |
|---|---|---|
| C₁₀₋₁₃-alkyl benzene sulfonic acid | 5.7% | 5.7% |
| and fatty alcohol ether sulfate with | | |
| 2 mol ethylene oxide | | |
| C₁₃₋₁₅-alkyl ether with 7 mol | 3.3% | 3.3% |
| ethylene oxide | | |
| Builder (citric acid and | 0.43% | 0.43% |
| phosphonates) | | |
| Caustic soda solution | 0.6% | 0.6% |
| Palm kernel oil fatty acid | 0.5% | 0.5% |
| Glycerol | 0.5% | 0.5% |
| Sodium chloride | 1.8% | 1.8% |
| Enzymes (protease, amylase, | 0.4% | 0.4% |
| cellulase, lipase) | | |
| Boric acid | 0.5% | 0.5% |
| Polyurethane (polyurethane-32) | — | 0.5% |
| Further additives (preservatives, | 0.49% | 0.49% |
| defoamer, optical brighteners, dye, | | |
| perfume) | | |
| Water | Remainder | Remainder |

### Embodiment Example 2

### Measurement Method

The frictional resistance of the different fabrics (cotton fabric and polyester/cotton mixed fabric) was determined after washing. This test method serves to determine the resistance which contrasts a textile surface of a friction stress by a friction body.

Test Conditions:

| Sample width | 100 | mm |
|---|---|---|
| Sample length | 250 | mm |
| Test length (friction distance) | 100 | mm |
| Weight of the friction body | 175 | g (Teflon) |
| Dimensions of the friction body | 71 mm × 56 mm | |
| Inspection speed | 300 | mm/min |

| | |
|---|---|
| Test direction | horizontal |

A Zwick Z010 was used for measurement.

The Teflon friction body was positioned in the center at the end of the measurement sample. The friction body was moved to the other end of the measurement sample by starting the tensile tester.

The path covered was then recorded in a power/length variation diagram.

The surface smoothness of a textile can be determined directly using this method. The less force required to move the frictional resistance over the textile, the smoother the surface of the textile.

The measurement results are represented below in graphic and tabular form, wherein “New” means the values of the textiles directly after purchase (without a washing cycle). “Formulation 1” covers fabrics washed with conventional agent according to formulation 1; the same applies to the measurement values called “formulation 2” which were obtained using the agent according to the invention.

Cotton Fabric (100% Cotton):

| | New | Formulation 1 | Formulation 2 |
|---|---|---|---|
| Average value [cN] | 29.4 | 39.5 | 31.7 |

Polyester/cotton Mixed Fabric (65 wt.-% Polyester, 35 wt.-% Cotton)

| | New | Formulation 1 | Formulation 2 |
|---|---|---|---|
| Average value [cN] | 32.2 | 36.3 | 29.6 |

The fabrics treated with the formulations according to the invention display a similar resistance to the unwashed fabrics, whereas a greater force is necessary using conventional detergents. This indicates a high resistance, thus more creases and fewer smooth fibers of the fabric. Reduced creasing of fabric and easier ironing is thus possible using the polyurethanes according to the invention.

What is claimed is:

1. A detergent or cleaning agent for textiles comprising at least one polyurethane as anti-crease agent, wherein the polyurethane can be obtained by reacting
A) at least one ether of the general formula HO—(ZO)ₙ—H
in which Z stands for an aliphatic hydrocarbon functional group with 2 to 10 carbon atoms, or for a cycloaliphatic hydrocarbon functional group with 5 to 12 carbon atoms,
and
n stands for a number greater than or equal to 2,
with
B) at least one aliphatic and/or cycloaliphatic diisocyanate, and
C) optionally at least one compound with at least two amino groups which, independently of one another, are selected from the primary amino group or secondary amino group.

2. The detergent or cleaning agent for textiles according to claim 1, characterized in that der the ether is an aliphatic, saturated ether of the general formula HO—((CH₂)ₘO)ₙ—H,
wherein
m stands for an integer from 2 to 12,
and
n stands for a number greater than or equal to 2.

3. The detergent or cleaning agent for textiles according to claim 1, characterized in that the polyurethane forms a film on a surface and the film forms a contact angle with water of 80° or more.

4. The detergent or cleaning agent for textiles according to claim 1, characterized in that the polyurethane forms a film on a surface and the film has a tensile strength of less than 40 MPa.

5. The detergent or cleaning agent for textiles according to claim 1, characterized in that the polyurethane determines a glass transition temperature determined according to DIN EN 61006 of −50° C. or less.

6. The detergent or cleaning agent for textiles according to claim 1, characterized in that the at least one diisocyanate comprises hexamethylene diisocyanate and/or isophorone diisocyanate.

7. The detergent or cleaning agent for textiles according to claim 1, characterized in that the at least one compound with at least one amino group is selected from the group which contains C₂- to C₁₂-alkyl diisocyanates, C₆- to C₁₂-cyclohexyl diisocyanates, 1-methyl-2,4-diisocyanato-cyclohexane, 1,6-diisocyanato-2,2,4-trimethylhexane, 1,6-diisocyanato-2,4,4-trimethylhexane (TMDI), tetramethoxybutane-1,4-diisocyanate, butane-1,4-diisocyanate, hexane-1,6-diisocyanate (hexamethylene diisocyanate, HDI), 4,4′-methylenebis(cyclohexyl isocyanate) (H₁₂MDI), cyclohexane-1,4-diisocyanate, isophorone diisocyanate (5-isocyanato-1-isocyanatomethyl-1,3,3-trimethyl cyclohexane, IPDI), ethylene diisocyanate as well as mixtures thereof.

8. The detergent or cleaning agent for textiles according to claim 1, characterized in that is basic and has a pH of greater than 7.

9. The detergent or cleaning agent for textiles according to claim 1, characterized in that the polyurethane is an anionically-modified polyester polyurethane.

10. The detergent or cleaning agent for textiles according to claim 1, characterized in that it contains the polyurethane in a proportion of from 0.01 to 30 wt.-%.

11. A use of polyurethanes as defined in claim 1, as anti-crease agent for textiles.

12. A method for reducing creases in textiles during laundry, characterized in that a polyurethane as defined in claim 1 and in particular as a component of a detergent or cleaning agent is brought into contact with the textile.
